(19) United States
(12) Patent Application Publication
(10) Pub. No.: US 2016/0303688 A1
(43) Pub. Date: Oct. 20, 2016

(54) Gas Enclosure and Particle Shield for Laser Welding System

(71) Applicant: Ford Motor Company, Dearborn, MI (US)

(72) Inventors: Urban J. De Souza, Rochester Hills, MI (US); Yunan Guo, Rochester Hills, MI (US)

(21) Appl. No.: 14/690,853

(22) Filed: Apr. 20, 2015

(51) Int. Cl. B23K 26/70; B23K 26/16; B23K 26/142; B23K 26/21; B23K 26/12

(52) U.S. Cl. CPC B23K 26/706; B23K 26/21; B23K 26/123; B23K 26/142; B23K 26/16

(57) ABSTRACT

A laser welding system and method of joining a plurality of parts includes a shielding enclosure assembly. The shielding enclosure assembly includes a tubular enclosure and is provided with a gas supply port and a gas evacuation port. An isolator is provided between a bottom end of the tubular enclosure and parts to be joined to contain shielding gas and may also provide electrical insulation insulating the shielding enclosure assembly from the parts to be joined.

### TECHNICAL FIELD

This disclosure relates to a shielding enclosure for an inert gas shielded laser welding tool.

### BACKGROUND

Deep penetration keyhole laser welding is a joining process that may be used to weld sheets or other parts together. Laser welding may be used to join similar and dissimilar metals together (such as e.g. A1 1100-0 and Cu 11000-H4). Laser welding may be automated to provide a large number of precisely located welds for joining high voltage electrical systems such as battery terminals for the batteries of electric vehicles or for welding vehicle body components such as inner and outer door closure panels.

Weld splatter particles may be created and may become airborne as a by-product of deep penetration keyhole laser welding. Weld splatter particles (<1 mm in size) are randomly distributed in the area of the laser welding operation and may cause conductive contamination or plastic burns on adjacent high voltage electrical system components and may cause bridging or grounding of conductors.

Laser welding vehicle body components such as inner and outer door closure panels may also result in depositing weld splatter on visible Class-A surfaces. Weld splatter on Class-A surfaces is unacceptable and must be mechanically removed prior to painting the body-in-white.

Laser welding does not require filler metal or welding rods because the weld is created by locally heating the parts to be joined. The only consumable material for laser welding is the gas used for shielding that may be helium gas, argon gas, carbon dioxide, or other gaseous compositions and combinations that are used to prevent combustion at the weld location and improve weld quality.

The above problems and other problems are addressed by this disclosure as summarized below.

### SUMMARY

According to one aspect of this disclosure, a laser welding tool is disclosed for joining a plurality of parts. The tool includes a laser welding head that emits a laser beam and tubular enclosure defining an open ended chamber through which the laser beam is projected towards the parts. A gas supply port and a gas evacuation port are provided on the enclosure with the evacuation port being spaced from the supply port. An isolator is provided between the end of the enclosure and the parts to be joined by welding.

According to other aspects of the laser welding tool, the tubular enclosure may be a rigid rectangular housing (e.g. made of metal or glass) having an open top end and an open bottom end. An isolator may be provided that is a resilient polymeric material contoured to engage the parts during a welding operation to prevent weld splatter from escaping the enclosure between the enclosure and the parts. The isolator also may electrically insulate the enclosure from the parts.

The gas supply port may be connected in a fluid flow relationship to a supply of shielding gas and provides a flow of shielding gas to the enclosure. The gas evacuation port may be connected to an area of reduced air pressure in a fluid flow relationship that draws shielding gas and smoke from inside the enclosure. The laser welding tool may also include an air knife that directs air across an open top end of the enclosure to remove smoke from above the enclosure.

The weld splatter created by the laser beam is blocked by the enclosure and may be drawn from the enclosure through the evacuation port. The isolator spans the space between the enclosure and the parts to prevent weld splatter from being deposited on the parts outside of the isolator and enclosure.

According to another aspect of this disclosure, a method of welding a plurality of parts is disclosed. The method comprises the steps of assembling parts to be joined in a fixture and providing an enclosure including a gas supply port connected to a source of a shielding gas, and a gas evacuation port connected to a vacuum source. The enclosure reduces the volume of shielding gas required to perform the laser welding method. The parts are contacted by the enclosure to block weld splatter and shielding gas from escaping the enclosure at a bottom end of the enclosure. The shielding gas is supplied to the enclosure through the gas supply port as a laser beam is projected through the enclosure and onto the parts to weld the parts together. The shielding gas and weld splatter may be exhausted through the gas evacuation port.

According to other aspects of the method, the enclosure blocks weld splatter from escaping from inside the enclosure and being deposited on the parts outside the enclosure. The method may further comprise directing air across an upper end of the enclosure with an air knife to direct smoke away from the top end of the enclosure.

The method may also further comprise compressing an isolator with the enclosure against the parts. The enclosure may be clamped against the parts to close any gaps between the isolator and the parts.

According to another aspect of this disclosure a system is disclosed for welding a bus bar module to a terminal of a prismatic cell. The system includes a laser welding head that emits a laser beam and a tubular enclosure defining an open ended chamber through which the laser beam is projected toward the bus bar and terminal. A supply port is provided for shielding gas on the enclosure. An evacuation port is provided at a location spaced from the supply port for removing shielding gas from the enclosure. An isolator is provided between an end of the enclosure and the bus bar module.

According to other aspects of the system a clamp is provided that engages the enclosure and compresses the isolator against the bus bar to close any gaps between the isolator and the bus bar. The isolator electrically insulates the enclosure from the bus bar. The bus bar may include a plurality of areas that the isolator is adapted to contact. The laser beam emitted by the laser welding head may include a plurality of laser beams for joining the bus bar to a plurality of terminals.

The above aspects of this disclosure and other aspects are described below with reference to the attached drawings.

### BRIEF DESCRIPTION OF THE DRAWINGS

FIG. 1 is a schematic partially cross-sectional view showing a laser welding tool having an inert gas shield made according to this disclosure.

FIG. 2 is a schematic partially cross-sectional view of the laser welding tool illustrated in FIG. 1 showing the inert gas shield with diagrammatically illustrated laser beams.

FIG. 3 is a cross-sectional view of the inert gas shield in contact with a bus bar showing two linear laser weld stitches formed within the confines the inert gas shield.

FIG. 4 is a cross-sectional view of the inert gas shield in contact with a bus bar showing a circular laser weld formed within the confines the inert gas shield.

FIG. 5 is a schematic partially cross-sectional view of the inert gas shield showing bus bars joining three pairs of terminals that are disposed within the shield.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

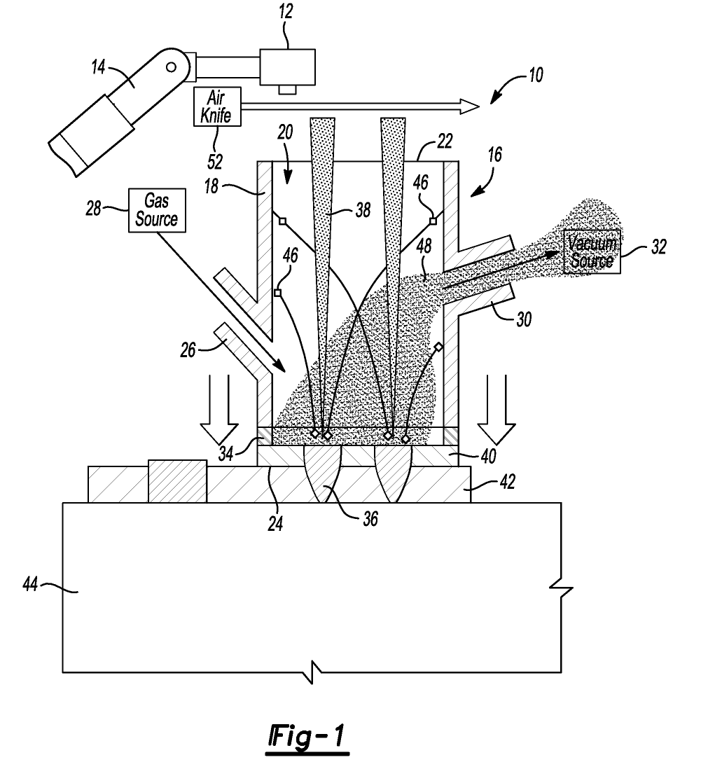

Referring to FIG. 1, a laser welding system 10 is illustrated that includes a laser welding head 12 moved by a robot arm 14. A shielding enclosure assembly 16 is provided for the laser welding system 10 and is aligned with a laser welding head 12.

The shielding enclosure assembly 16 includes a tubular enclosure 18 that defines an open ended chamber 20 including an open top end 22 and an open bottom end 24. The tubular enclosure 18 is rigid and may be formed of metal or glass. A gas supply port 26 is provided on the tubular enclosure 18 that is in fluid flow communication with a gas source 28. The gas source 28 is a pressurized vessel that may be filled with helium, argon, CO₂, or combinations thereof. The gas evacuation port 30 is provided on the tubular enclosure 18 at a spaced location relative to the gas supply port 26. The gas evacuation port 30 is in fluid flow communication with a vacuum source 32 or other low pressure area. The vacuum source 32 may be a motor driven vacuum pump, or the like.

An isolator 34 is provided at the bottom end 24 of the tubular enclosure 18. The isolator 34 may be a polymeric or elastomeric ring that is attached to the bottom end 24 of the rigid tubular enclosure 18. The isolator 34 is preferably formed of an elastomeric material that provides electrical insulation for the bottom end 24 of the tubular enclosure 18. The isolator 34 is resilient to facilitate engaging the surfaces of the parts to be joined. Alternatively, the isolator may be part of a bus bar frame.

The tubular enclosure 18 may be a rectangular enclosure or may take another form such as a cylindrical, square or oval shaped tubular member or may be an irregular or custom shaped tubular body.

A deep penetration keyhole laser weld 36 is formed by a laser beam 38 projected by the laser welding head 12. For example, the laser weld 36 may be used to join a bus bar 40 to a terminal 42 of a prismatic battery cell 44. The bus bar 40 may also be referred to as a bus bar module that includes a frame. As shown in FIG. 1, a plurality of prismatic battery cells is illustrated that each includes the terminal 42. The bus bar 40 and terminal 42 are one example of a plurality of parts that are intended to be welded together by the laser welding system 10. Instead of the bus bar 40 in terminal 42, the parts could also be an inner body part and an outer body part or any other plurality of parts that are to be welded together by the laser welding system 10.

A plurality of weld spatter particles 46 are shown being expelled from the laser weld 36 that are formed when the laser beam 38 heats the parts 40 and 42. The particles 46 are contained within the shielding enclosure assembly 16 and may also be removed from the tubular enclosure 18 by being drawn through the gas evacuation port 30. Smoke 48 is also shown in the open ended chamber 20 that is being drawn through the gas evacuation port 30. The smoke 48 and weld splatter particles 46 are drawn by vacuum created by the vacuum source 32 and may be routed through a filter (not shown) prior to reaching the vacuum source 32. An air knife 52 may be used to clear smoke from above the enclosure 18.

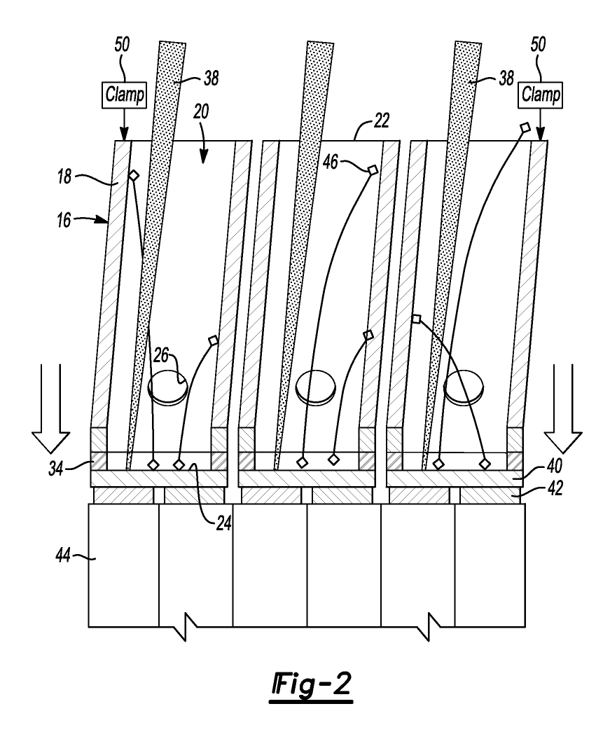

Referring to FIG. 2, the shielding enclosure assembly 16 is illustrated is a view rotated 90 degrees from FIG. 1. Three laser beams 38 are projected through three tubular enclosures 18 shown in FIG. 2. It should be understood that one or any number of shielding enclosure assemblies 16 may be provided depending upon the parameters and constraints of the manufacturing operation. Each shielding enclosure assembly includes a tubular enclosure 18 having an open top end 22 and an open bottom end 24. In the section shown in FIG. 2, only the gas supply ports 26 are shown. It should be understood that gas evacuation ports 30 are also provided on the tubular enclosure 18 in the portion not illustrated in FIG. 2.

The isolator 34 is shown at the bottom end 24 of the tubular enclosures 18. The isolators 34 are shown contacting the bus bar 40. The bus bar 40 is intended to be joined to the terminals 42 by the welding operation. The terminals 42 are electrical terminals that are provided on the prismatic battery cells 42. The isolator 34 is formed of a resilient relatively soft material so that it may effectively form a seal against a bus bar 40. It should be understood that the isolator 34 may contact one part or two parts at the same time, depending upon the structure of the parts to be joined, and that there may be some gaps between the isolator and the surfaces. The isolator 34 may be independent from the enclosure 18. For example, a plastic portion of a bus bar module or frame disposed between the enclosure and the parts may perform the function of the isolator.

A clamp 50 is shown diagrammatically exerting a clamping force against the shielding enclosure assembly 16. The clamp 50 causes the isolators 34 to contact and conform to the parts 42 to be welded. A plurality of weld splatter particles 46 that are shown to be confined within the shield enclosure assembly 16 are shown in FIG. 2.

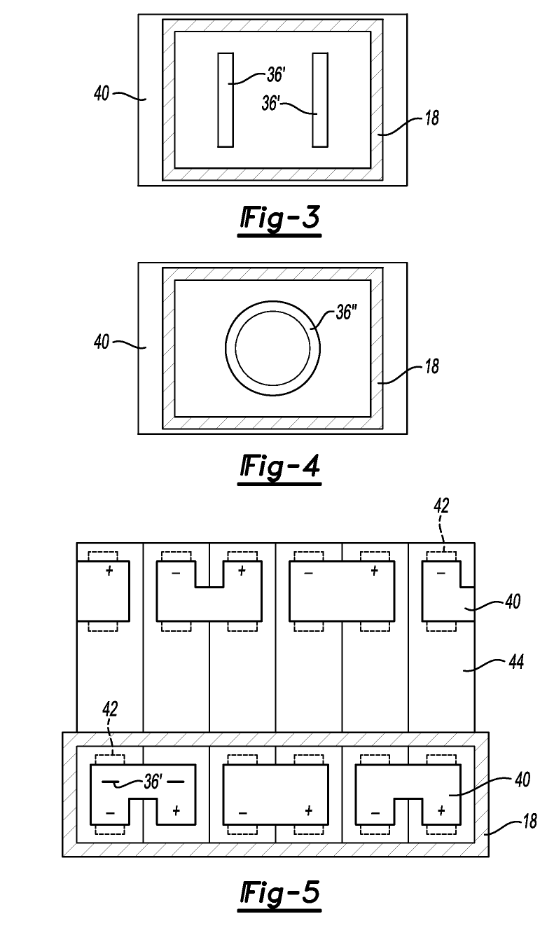

Referring to FIG. 3, a plan view of a bus bar 40 (or other type of part) is shown that is taken in a cross section through the tubular enclosure 18. A pair of linear stitch welds 36′ are shown to be formed on the part 40.

In another embodiment shown in FIG. 4, the part 40 is shown to be partially enclosed by the tubular enclosure 18. A circular weld 36″ is shown within the enclosure 18 is shown to be formed on the part 40.

Referring to FIG. 5, a set of prismatic battery cells 44 are shown to include a bus bar 40 being welded to terminals 42 of the prismatic cells 40. The tubular enclosure 18 is shown enclosing three sets of bus bars 40.

The method of welding a plurality of parts 40, 42 comprises assembling the parts to be joined in a fixture. An enclosure 18 is provided that may include an isolator 34, a gas supply port 26 connected to a source of a shielding gas 28, and a gas evacuation port 30 connected to a vacuum source 32. The isolator 34 is disposed between the parts 40, 42 to be joined and the enclosure 34 to electrically isolate the enclosure 18 from the parts and block weld splatter 46 and shielding gas from escaping through the bottom end 24 of the enclosure 18. The shielding gas is supplied to the enclosure 18 through the gas supply port 26. A laser beam 38 is projected through the enclosure 18 and onto the parts to weld the parts together. Shielding gas, fumes and weld splatter 46 may be drawn through the gas evacuation port 30.

The enclosure 18 blocks weld splatter 46 from escaping from inside the enclosure (except through the gas evacuation port 30) and being deposited on the parts outside the enclosure. Air may be directed across an upper end of the enclosure with an air knife 52 to direct smoke 48 away from the top end 22 of the enclosure 18. The isolator 34 may be compressed by a clamp 50 pressing the enclosure 18 against the parts to close or reduce the size of any gaps between the isolator and the parts.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A laser welding system for joining a plurality of parts comprising:
a laser welding head that emits a laser beam;
tubular enclosure defining an open ended chamber through which the laser beam is projected towards the parts;
a gas supply port provided on the enclosure;
a gas evacuation port spaced from the supply port on the enclosure; and
an isolator provided between an end of the enclosure and the parts.

2. The laser welding system of claim 1 wherein the tubular enclosure is a rigid rectangular housing having an open top end and an open bottom end.

3. The laser welding system of claim 1 wherein the isolator is a resilient polymeric material that is contoured to engage the parts during a welding operation to prevent weld splatter from escaping the enclosure between the enclosure and the parts.

4. The laser welding system of claim 3 wherein the isolator electrically insulates the enclosure from the parts.

5. The laser welding system of claim 1 wherein the gas supply port is connected in a fluid flow relationship to a supply of shielding gas and provides a flow of shielding gas to the enclosure.

6. The laser welding system of claim 1 wherein the gas evacuation port is connected to an area of reduced air pressure in a fluid flow relationship that draws shielding gas and smoke from inside the enclosure.

7. The laser welding system of claim 1 further comprising an air knife that directs air across an open top end of the enclosure to remove smoke from above the enclosure.

8. The laser welding system of claim 1 wherein weld splatter created by the laser beam is blocked by the enclosure and may be drawn from the enclosure through the evacuation port.

9. The laser welding system of claim 1 wherein the isolator contacts the parts spanning the space between the enclosure and the parts to prevent weld splatter from being deposited on the parts outside of the isolator and enclosure.

10. A method of welding a plurality of parts comprising:
assembling parts to be joined in a fixture;
providing an enclosure including a gas supply port connected to a source of a shielding gas, and a gas evacuation port connected to a vacuum source;
contacting the parts to be joined with the enclosure to block weld splatter and shielding gas from escaping the enclosure at a bottom end of the enclosure;
supplying the shielding gas to the enclosure through the gas supply port;
projecting a laser beam through the enclosure and onto the parts to weld the parts together; and
exhausting shielding gas and weld splatter through the gas evacuation port.

11. The method of claim 10 wherein the enclosure inhibits weld splatter from escaping from inside the enclosure and being deposited on the parts outside the enclosure.

12. The method of claim 10 further comprising:
directing air across a top end of the enclosure with an air knife to direct smoke away from the top end of the enclosure.

13. The method of claim 10 further comprising:
compressing an isolator with the enclosure against the parts.

14. The method of claim 10 further comprising:
insulating the enclosure from the parts with an isolator.

15. The method of claim 10 further comprising:
clamping the enclosure and an isolator against the parts to close any gaps between the isolator and the parts.

16. A system for welding a bus bar module to a terminal of a prismatic cell comprising:
a laser welding head that emits a laser beam;
tubular enclosure defining an open ended chamber through which the laser beam is projected toward the bus bar and terminal;
a supply port for shielding gas provided on the enclosure;
an evacuation port for shielding gas provided on the enclosure at a location spaced from the supply port; and
an isolator provided between an end of the enclosure and the bus bar module.

17. The system of claim 16 further comprising:
a clamp engaging the enclosure and compressing the isolator against the bus bar to close any gaps between the isolator and the bus bar.

18. The system of claim 16 wherein the isolator insulates the enclosure from the bus bar.

19. The system of claim 16 wherein the bus bar includes a plurality of areas on the bus bar that the isolator is adapted to contact, wherein the laser beam emitted by the laser welding head includes a plurality of laser beams for joining the bus bar to a plurality of terminals.
